(19) United States
(12) Patent Application Publication
(10) Pub. No.: US 2026/0170305 A1
(43) Pub. Date: Jun. 18, 2026

(54) DEEP LEARNING ARCHITECTURE FOR MULTIVARIATE TIME SERIES

(71) Applicants: International Business Machines Corporation, Armonk, NY (US); Massachusetts Institute of Technology, Cambridge, MA (US)

(72) Inventors: Quang Minh Nguyen, Cambridge, MA (US); Lam Minh Nguyen, Ossining, NY (US); Subhro Das, Cambridge, MA (US)

(21) Appl. No.: 18/981,478

(22) Filed: Dec. 14, 2024

(51) Int. Cl. G06N 3/0455; G06N 3/048; G06N 3/088

(52) U.S. Cl. CPC G06N 3/0455; G06N 3/048; G06N 3/088

(57) ABSTRACT

A machine learning system includes input embedding layers, a positional encoder configured to encode an embedding generated by the input embedding layers and N encoder blocks; each block includes a mixture-of-head-attention mechanism; a first add and normalization mechanism configured to process an output of the mixture-of-head-attention mechanism; a feed forward mechanism configured to process an output of the first add and normalization mechanism; and a second add and normalization mechanism configured to process an output of the feed forward mechanism. The mixture-of-head-attention mechanism includes a temporal-attention block configured to process an output of the positional encoder and comprising a temporal-attention head and input linear transformers; a correlated attention block configured to process the output of the positional encoder; a lagged cross-correlation filtering mechanism configured to carry out representation learning of correlation features; a concatenator; and a combined linear transformer.

### BACKGROUND

The present invention relates generally to the electrical, electronic and computer arts and, more particularly, to machine learning.

Multivariate time series (MTS) forecasting and analysis are important tools in real-world applications, such as finance, climate science, and healthcare. Real-world datasets are complex, potentially with hundreds of features. Cross-correlation in MTS data is the correlation between different variates of the MTS, which inherently stems from complex real-world systems, and has been neglected by conventional MTS architectures. The temporal attention mechanism, which is the workhorse of the prevalent transformer-based models for MTS, does not capture cross-correlation across features, thereby resulting in potentially sub-optimal performance on real-world datasets. Moreover, existing work is limited in terms of the type of cross-correlation and MTS tasks, or non-competitive as a result of not deploying state-of-the-art (SOTA) transformer-based models. The existing work is limited in terms of the type of cross-correlation and MTS tasks that can be performed. In particular, a major body of literature is focused on forecasting with spatio-temporal correlation, or is applicable to only specific uncommon tasks, such as compression, pattern discovery, or statistical analysis, while some approaches seek to design ad-hoc models for a specific domain.

### BRIEF SUMMARY

Principles of the invention provide systems and techniques for a deep learning architecture for multivariate time series. In one aspect, an exemplary machine learning system, according to an aspect of the invention, includes input embedding layers; a positional encoder configured to encode an embedding generated by the input embedding layers; and N encoder blocks. Each encoder block includes: a mixture-of-head-attention mechanism; a first add and normalization mechanism configured to process an output of the mixture-of-head-attention mechanism; a feed forward mechanism configured to process an output of the first add and normalization mechanism; and a second add and normalization mechanism configured to process an output of the feed forward mechanism. The mixture-of-head-attention mechanism includes: a temporal-attention block configured to process an output of the positional encoder and including a temporal-attention head, a Q linear transformer configured to perform a linear transformation to generate a Q input for the temporal-attention head, a K linear transformer configured to perform a linear transformation to generate a K input for the temporal-attention head and a V linear transformer configured to perform a linear transformation to generate a V input for the temporal-attention head. A correlated attention block is configured to process the output of the positional encoder and includes a score aggregator, a Q linear and normalization module configured to generate a correlated Q output, a K linear and normalization module configured to generate a correlated K output and a correlated V linear transformer configured to generate a correlated V output. A lagged cross-correlation filtering mechanism is configured to process outputs of the Q linear and normalization module and the K linear and normalization module, configured to carry out representation learning of correlation features including a top k highest correlation important scores to be filtered out, where k is a controlled parameter, and configured to produce an output for the score aggregator. A concatenator is configured to concatenate an output of the temporal-attention head and an output of the score aggregator. A combined linear transformer is configured to process an output of the concatenator.

In one aspect, a computer program product includes one or more tangible computer-readable storage media and program instructions stored on at least one of the one or more tangible computer-readable storage media, the program instructions executable by a processor to cause the processor to instantiate the machine learning system.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action other than by performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
deep learning transformer-based architectures for MTS forecasting and analysis;
an MTS architecture that captures cross-correlation information of MTS data and is applicable to a wide range of prevalent tasks including, imputation, classification, anomaly detection, forecasting and the like;
a correlation-attention mechanism that can capture cross-correlation information between different features of the MTS data;
integration of a cross-correlation attention mechanism into a transformer-based architecture, where the transformer-based architecture guarantees generality of the model for application to a wide range of tasks as well as efficiency;
automatic detection of both instantaneous and lagged correlation across features;
improves the technological process of machine learning by providing an improved transformer (e.g., improved accuracy) for gesture, action and audio recognition, medical diagnosis by heartbeat monitoring and other practical tasks; and
the incorporation of decoder layers into a second example correlated transformer that leads to better performance on predictive tasks, such as forecasting, thereby improving the technological process of machine learning.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1A is a high-level block diagram of a first example correlated transformer, in accordance with example embodiments;

FIGS. 1B-1C illustrate equations that define operations of the correlation-attention head (CAB) 276 of encoder blocks and the masked CAB of decoder blocks, respectively, in accordance with example embodiments;

FIG. 1D is a high-level block diagram of a second example correlated transformer, in accordance with example embodiments;

FIG. 2 is a table of the extensive set of datasets that were utilized in testing, in accordance with example embodiments;

FIG. 3 is a table of results for an imputation task over six datasets, in accordance with example embodiments;

FIG. 4 is a table of results for an anomaly detection task over five datasets, in accordance with example embodiments;

FIG. 5 is a table of results for a classification task over ten datasets from, in accordance with example embodiments;

FIG. 6 is a table of results for a long-term forecasting task over three datasets, in accordance with example embodiments; and

FIG. 7 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Generally, one or more embodiments provide an MTS architecture that captures cross-correlation information of MTS data. The MTS architecture, referred to as correlated transformer herein, is applicable to a wide range of prevalent tasks, including imputation, classification, anomaly detection, and forecasting. Pertinent to the correlated transformer is a correlation-attention mechanism that can capture cross-correlation information between different features of the MTS data (both the instantaneous and lagged cross-correlation information) to improve the overall performance of the transformer. One or more exemplary embodiments tackle the problem of MTS forecasting and analysis in a real-world scenario, which prevalently exhibits correlation across variates/features of the MTS data. Exemplary embodiments are applicable to a wide range of fields and industries, including finance, healthcare, and climate change.

The transformer-based architecture captures the cross-correlation information through a correlation-attention mechanism at its core. The underlying transformer-based architecture guarantees generality of the disclosed model for application to a wide range of tasks as well as efficiency. A conventional temporal-attention mechanism, which is the workhorse of state-of-the-art models for MTS, does not capture cross correlation across features, thereby resulting in potentially suboptimal performance on real world data sets (such as data sets having up to hundreds of features). On the other hand, a correlated transformer in accordance with exemplary embodiments includes both temporal attentions and feature attentions, and thus can capture temporal dependencies as well as automatically detecting cross correlations between different features of the MTS dataset which are inherent in complex systems, yet ignored by conventional solutions.

### System Overview

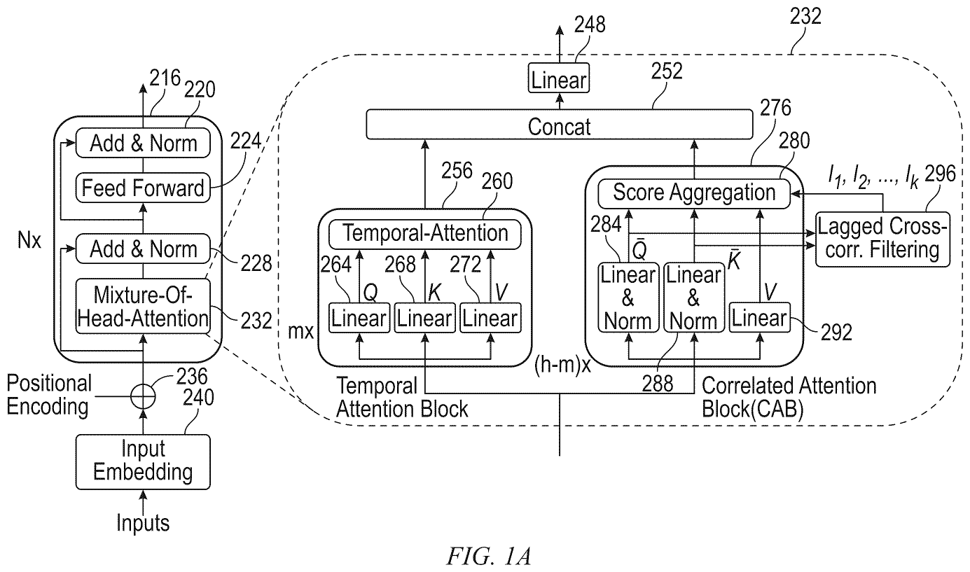

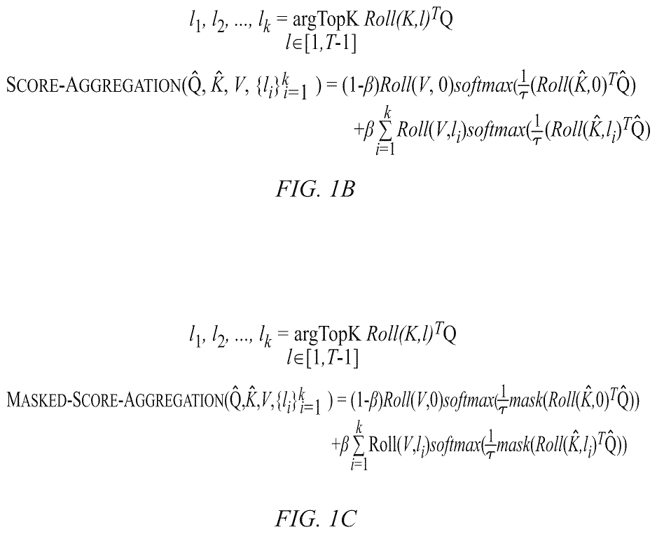

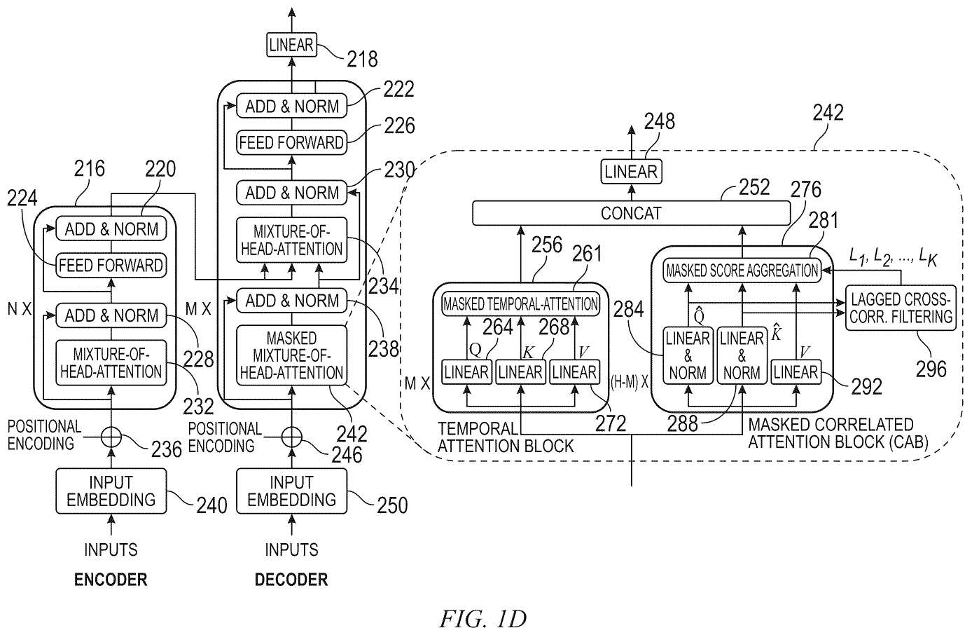

FIG. 1A is a high-level block diagram of a first example correlated transformer, in accordance with example embodiments. The correlated transformer passes an input through input embedding layers 240, followed by N encoder blocks 216. In example embodiments, the outputs of the N encoder blocks 216 are passed through M decoder blocks (see FIG. 1D and the associated text). The correlated transformer replaces the conventional multi-head-attention with a mixture-of-head-attention and, additionally, deploys an example correlated attention block (CAB) 276. Unlike the usual temporal-attention architecture, the CAB 276 performs normalization of the Q and K inputs, integrates a lagged cross-correlation filtering mechanism 296 for representation learning of the most important correlation features and deploys a score aggregator 280 based on the filtered information. In example embodiments, the architecture is implemented using the Python language and a known framework for programming in the Python language, of which PyTorch and TensorFlow are non-limiting examples (also, languages other than Python could be used in other embodiments).

As described above, the correlated transformer first passes the input through the input embedding layers 240, followed by the N encoder blocks 216. In example embodiments, the output of the N encoder blocks 216 are passed to M decoder blocks. The input embedding layer 240 adopts a conventional positional encoding 236 to integrate the information of sequence order.

In example embodiments, a mixture-of-head-attention block 232 computes multiple attention heads, and concatenates all the heads to be passed to a linear transformation. The attention heads can be, for example, one of the following:
a conventional temporal-attention head 256; and
a correlation-attention head (CAB) 276.

FIGS. 1B-1C illustrate equations that define operations of the correlation-attention head (CAB) 276 of encoder blocks and the masked CAB of decoder blocks, respectively, in accordance with example embodiments. Given Q, K, and V as inputs, the CAB 276 implements the equations of FIG. 1B, where Tis the sequence length of the MTS data, t and β are learnable parameters, and k is a hyperparameter. (It is noted that the skilled artisan will be familiar with the different variables set forth; variables that are application-dependent can be selected heuristically given the teachings herein.) If a decoder block(s) is (are) deployed, the masked CAB performs the equations of FIG. 1C. In example embodiments, k=[c*log (T)] for c=1, 2, 3 and the best result of c=1, 2, 3 is utilized. In example embodiments, the model with the respective c that achieves the best performance within c=1, 2, 3 is used. The performance metrics, such as accuracy, mean square error (MSE), and the like, depend on the application of interest.

As in a conventional transformer, the output of the positional encoding 236 is fed to the temporal-attention mechanism 256 where linear blocks 264, 268, 272 perform a standard linear transformation to generate the Q, K and V inputs for the temporal-attention layer 260. The output of the temporal-attention mechanism 256 is fed into a concatenator 252.

In addition, unlike conventional transformer architectures where both the encoder blocks 216 and decoder blocks are based on a conventional self-attention mechanism, the mixture-of-head-attention block 232 leverages a mixture of the conventional self-attention heads and the correlation attention heads (CAB) 276. In example embodiments, correlation attention includes three steps: lagged series generation, cross correlation filtering 296 and score aggregation 280. Initially, linear and normalization (norm) blocks 284, 288, 292 perform a standard linear transformation in a neural network, which generates the V value and is followed immediately by a norm-2 normalization (as supported, for example, by PyTorch or the like) to generate \hat{Q}, \hat{K}, respectively. Then, in lagged series generation, a lagged version of the keys and values of the MTS are artificially generated, and cross-correlation matrices between the lagged keys and the queries are computed. (In the equations in of FIGS. 1B-1C, the lagged version is Roll(K,lᵢ) and Roll (V,lᵢ) generated by using the Roll operation supported by PyTorch or the like.)

In the cross-correlation filtering 296, the sums of all entries of the cross-correlation matrices are computed (referred to as correlation importance scores herein), so that the top k highest correlation important scores are filtered out, where k is a controlled parameter. (It is noted that the skilled artisan is familiar with controlled parameters; the k parameter can be selected heuristically given the teachings herein.) In the score aggregation 280, those top k cross-correlation matrices chosen in the cross-correlation filtering step are passed through the softmax operation and then pre-multiplied by the lagged values computed in the lag series generation step, before being all summed up for the final score output. The score output is then concatenated, using concatenator 252, with the output (m vectors) of the temporal-attention mechanism 256 and a linear block 248 performs a standard linear transformation on the output of the concatenator 252. The output of the mixture-of-head-attention block 232 is provided to add and normalization (norm) block 228 of the correlated transformer to perform an add and a standard norm-2 normalization in PyTorch or the like on the output of linear block 248. Feed forward block 224 performs two linear transformations with a rectified linear unit (ReLU) activation function between them, all of which are supported by PyTorch or the like. Add and normalization (norm) block 220 of the correlated transformer then performs an add and a standard norm-2 normalization on the outputs of the feed forward block 224 and the output of the add and normalization block 228. It is noted that roll and softmax operations are supported by PyTorch or the like.

FIG. 1D is a high-level block diagram of a second example correlated transformer, in accordance with example embodiments. The incorporation of decoder layers into the second example correlated transformer leads to better performance on predictive tasks, such as forecasting, thereby improving the technological process of machine learning for forecasting applications. As noted above, in example embodiments, the outputs of the N encoder blocks 216 are passed through M decoder blocks. In example embodiments, some aspects of the decoder can be implemented using analogous components to the corresponding encoder. For example, add and normalization mechanism 222 may be implemented the same as add and normalization mechanism 220, feed forward mechanism 226 may be implemented the same as feed forward mechanism 224, add and normalization mechanisms 230, 238 may be implemented the same as add and normalization mechanism 228, and mixture-of-head-attention mechanism 234 may be the implemented same as mixture-of-head-attention mechanism 232. The masked mixture-of-head-attention mechanism 242 is similar to the mixture-of-head-attention mechanism 232, except the masked score aggregation 281 utilizes the masked equations of FIG. 1C and the masked temporal attention head 261 utilizes known masked temporal techniques. If deployed in the decoder, the masking operation replaces all the entries in the upper triangular part (excluding the diagonal of those matrices Roll (K,l)^{T}Q with negative infinity). (The masking operation can be implemented in PyTorch or the like.)

Similar to the encoder, the input embedding layer 250 adopts a conventional positional encoding 246 to integrate the information of sequence order prior to inputting to the corresponding masked mixture-of-head-attention mechanism 242. In addition, a linear block 218 performs a standard linear transformation on the output of the corresponding decoder block.

### Methodology and Analysis

Experiments were conducted using example embodiments of the correlated transformer implemented with a conventional temporal-attention technique (referred to as Transformer+CAB Nonstationary+CAB herein). The results described below showcase the performance over state-of-the-art (SOTA) baselines on MTS tasks such as imputation, anomaly detection, and classification.

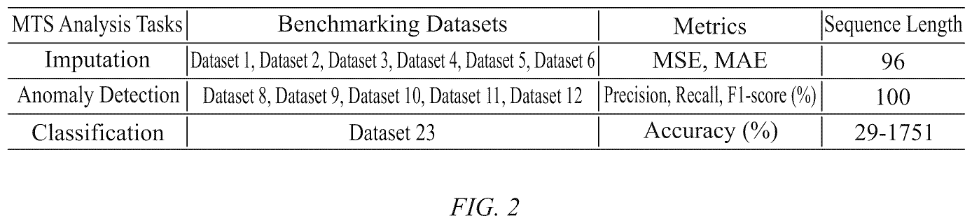

FIG. 2 is a table of the extensive set of datasets that were utilized in testing, in accordance with example embodiments. The testing was performed using a variety of benchmarking datasets and metrics on a number of MTS analysis tasks, including imputation, anomaly detection and classification.

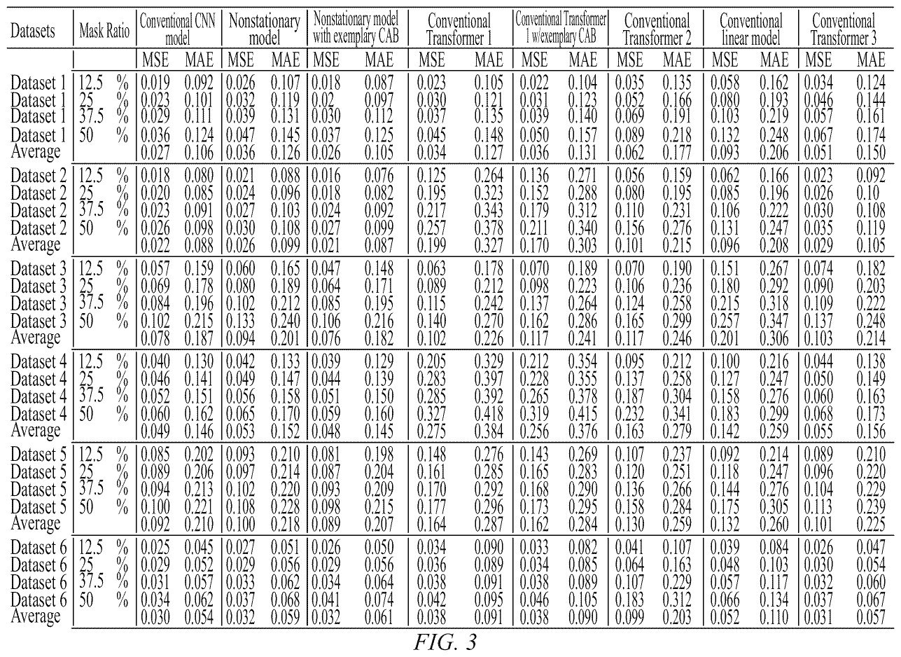

FIG. 3 is a table of results for an imputation task over six datasets, in accordance with example embodiments. For each dataset and technique, the missing data rate is {12.5%, 25%, 37.5%, 50%} and the series length is 96. The best and second-best results are highlighted.

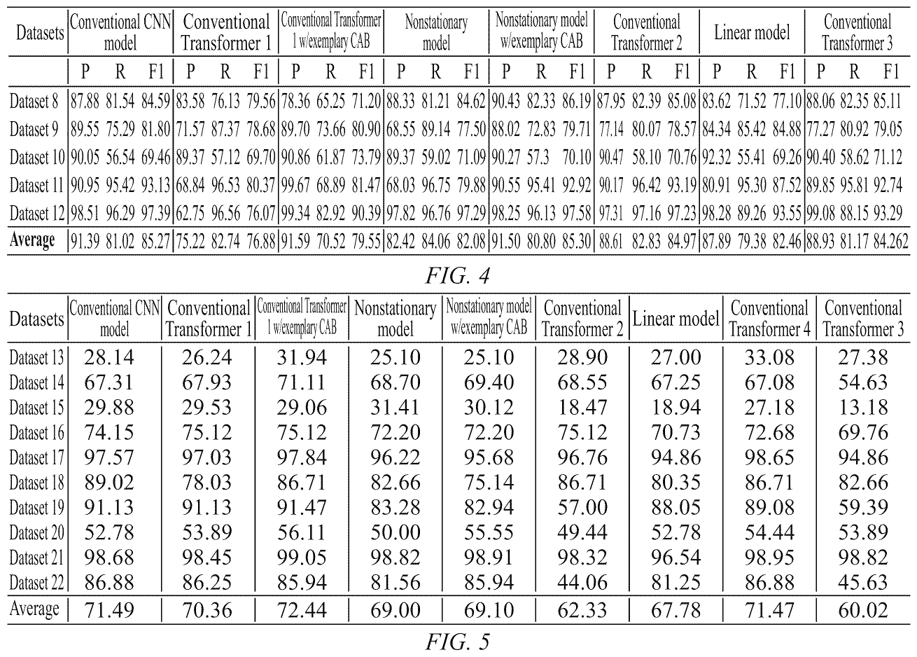

FIG. 4 is a table of results for an anomaly detection task over five datasets, in accordance with example embodiments. For each dataset and technique, the precision (P), the recall (R), and the F1-score (F1) are adopted as the metrics and reported, where the F1-score is the harmonic mean of precision and recall, and where higher values correspond to better performance. The best and second-best results are highlighted. The exemplary embodiment (using a conventional temporal-attention technique) achieves the best average F1-score, surpassing a conventional CNN-based model.

In the imputation task over six datasets, the exemplary embodiment consistently achieves SOTA results surpassing the conventional CNN-based model on five datasets. The mean square error (MSE) and mean absolute error (MAE) were adopted as the metrics.

FIG. 5 is a table of results for a classification task over ten datasets, in accordance with example embodiments. For each dataset and technique, the accuracies are adopted as the metric and reported. The best and second-best results are highlighted. An exemplary embodiment achieves the best overall result surpassing the conventional CNN-based model.

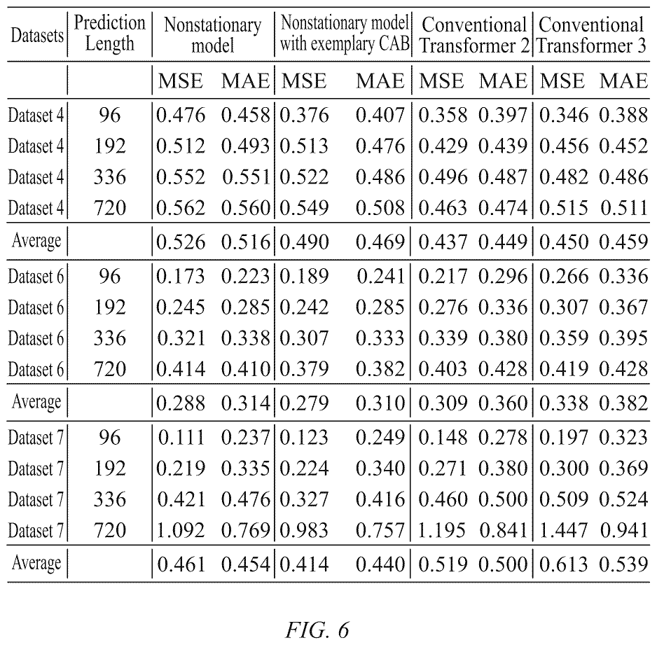

FIG. 6 is a table of results for a long-term forecasting task over three datasets, in accordance with example embodiments. Preliminary results where the exemplary embodiment outperforms the other SOTA transformers for the forecasting task on two datasets are showcased. The mean square error (MSE) and mean absolute error (MAE) are adopted as the metrics.

### Case Study 1

Weather/financial forecasting depends on high-dimensional MTS data where correlation is inherent. Adoption of the correlated transformer in accordance with aspects of the invention improves the performance of the task.

### Case Study 2

MTS classification is a pertinent task for a wide range of real-world scenarios, including gesture, action, and audio recognition; medical diagnosis by heartbeat monitoring; and other practical tasks. MTS classification on these tasks are covered in the experimental results described above.

Given the discussion thus far, it will be appreciated that, in general terms, an exemplary machine learning system, according to an aspect of the invention, includes input embedding layers 240; a positional encoder 236 configured to encode an embedding generated by the input embedding layers 240; and N encoder blocks 216. Each encoder block 216 includes: a mixture-of-head-attention mechanism 232; a first add and normalization mechanism 228 configured to process an output of the mixture-of-head-attention mechanism 232; a feed forward mechanism 224 configured to process an output of the first add and normalization mechanism 228; and a second add and normalization mechanism 220 configured to process an output of the feed forward mechanism 224. The mixture-of-head-attention mechanism 232 includes: a temporal-attention block 256 configured to process an output of the positional encoder 236 and including a temporal-attention head 260, a Q linear transformer 264 configured to perform a linear transformation to generate a Q input for the temporal-attention head 260, a K linear transformer 268 configured to perform a linear transformation to generate a K input for the temporal-attention head 260 and a V linear transformer 272 configured to perform a linear transformation to generate a V input for the temporal-attention head 260; a correlated attention block 276 configured to process the output of the positional encoder 236 and including a score aggregator 280, a Q linear and normalization module 284 configured to generate a correlated Q output, a K linear and normalization module 288 configured to generate a correlated K output and a correlated V linear transformer 292 configured to generate a correlated V output. Also included are a lagged cross-correlation filtering mechanism 296 configured to process outputs of the Q linear and normalization module 284 and the K linear and normalization module 288, configured to carry out representation learning of correlation features including a top k highest correlation important scores to be filtered out, where k is a controlled parameter, and configured to produce an output for the score aggregator 280; a concatenator 252 configured to concatenate an output of the temporal-attention head 260 and an output of the score aggregator 280; and a combined linear transformer 248 configured to process an output of the concatenator 252.

A standard linear transformation can be employed in one or more embodiments.

In one aspect, a computer program product includes one or more tangible computer-readable storage media and program instructions stored on at least one of the one or more tangible computer-readable storage media, the program instructions executable by a processor to cause the processor to instantiate any one, some, or all of the components of the machine learning system.

In example embodiments, an inferencing engine 200 is configured to perform inferencing using the encoder blocks and/or other described elements.

In example embodiments, the inferencing is for a task selected from the group consisting of gesture recognition, action recognition, audio recognition, and medical diagnosis by heartbeat monitoring.

In example embodiments, the lagged cross-correlation filtering mechanism 296 is further configured to generate lagged key matrices and values of multivariate time series (MTS), to compute cross-correlation matrices between the lagged key matrices and query matrices and to compute sums of all entries of the cross-correlation matrices to filter out the top k highest correlation important scores, wherein, in the score aggregation 280, a top k of the cross-correlation matrices chosen in a cross-correlation filtering step are passed through a softmax operation, pre-multiplied by lagged values computed in a lag series generation step, and summed to generate a final score output. In example embodiments, the computation of sums is based on called correlation importance scores.

In example embodiments, the first add and normalization mechanism 228 is configured to perform a norm-2 normalization on an output of the combined linear block 248.

In example embodiments, the feed forward mechanism 224 is configured to perform two feed forward linear transformations with a rectified linear unit (ReLU) activation function between the two feed forward linear transformations.

In example embodiments, the machine learning system includes a decoder positional encoder 246 (i.e., a positional encoder of the decoder) and M decoder blocks. Each decoder block includes: a mixture-of-head-attention mechanism 234 configured to process outputs of the corresponding encoder block 216; a masked mixture-of-head-attention mechanism 242 configured to process an output of the decoder positional encoder 246; a first decoder add and normalization mechanism 238 configured to process an output of the masked mixture-of-head-attention mechanism 242 and the output of the decoder positional encoder 246; a second decoder add and normalization mechanism 230 configured to process an output of the first decoder add and normalization mechanism 238 and an output of the mixture-of-head-attention mechanism 234; a decoder feed forward mechanism 226 configured to process an output of the second decoder add and normalization mechanism 230; and a third decoder add and normalization mechanism 222 configured to process an output of the decoder feed forward mechanism 226 and the output of the second decoder add and normalization mechanism 230. The decoder positional encoder is a positional encoder of the decoder.

In example embodiments, the masked mixture-of-head-attention mechanism 242 includes: a decoder temporal-attention block 256 configured to process the output of the decoder positional encoder 246 and including a masked temporal-attention head 261, a decoder Q linear transformer 264 configured to perform a linear transformation to generate a decoder Q input for the masked temporal-attention head 261, a decoder K linear transformer 268 configured to perform a linear transformation to generate a decoder K input for the masked temporal-attention head 261 and a decoder V linear transformer 272 configured to perform a linear transformation to generate a decoder V input for the masked temporal-attention head 261. Also included are a decoder correlated attention block 276 configured to process the output of the decoder positional encoder 246 and including a masked score aggregator 281, a decoder Q linear and normalization module 284 configured to generate a decoder correlated Q output, a decoder K linear and normalization module 288 configured to generate a decoder correlated K output and a decoder correlated V linear transformer 292 configured to generate a decoder correlated V output; a decoder lagged cross-correlation filtering mechanism 296 for representation learning of most important decoder correlation features, the most important decoder correlation features including a top k highest decoder correlation important scores to be filtered out, where k is a decoder controlled parameter;
a decoder concatenator 252 configured to concatenate an output of the masked temporal-attention head 261 and an output of the masked score aggregator 281; and a decoder combined linear transformer 248 configured to process an output of the decoder concatenator 252.

In example embodiments, each decoder correlated attention block 276 of each decoder block performs:

$$\begin{matrix}{l}_{1} , {l}_{2} , … , {l}_{k} = {argTopK}_{l ∈ [ 1 , T - 1 ]} {Roll ( K , l )}^{T} Q \\ MASKED - SCORE - AGGREGATION ( \hat{Q} , \hat{K} , V , {\{ {l}_{i} \}}_{i = 1}^{k} ) \\ = ( 1 - β ) Roll ( V , 0 ) softmax ( \frac{1}{T} mask ( {Roll ( \hat{K} , 0 )}^{T} \hat{Q} ) ) \\ + β {\sum }_{i = 1}^{k} Roll ( V , {l}_{i} ) softmax ( \frac{1}{T} mask ( {Roll ( \hat{K} , {l}_{i} )}^{T} \hat{Q} ) )\end{matrix}$$

where T is a sequence length of multivariate time series (MTS) data, t and β are learnable parameters, and k is a hyperparameter.

In example embodiments, each correlated attention block 276 of each encoder block performs:

$$\begin{matrix}{l}_{1} , {l}_{2} , … , {l}_{k} = {argTopK}_{l ∈ [ 1 , T - 1 ]} {Roll ( K , l )}^{T} Q \\ SCORE - AGGREGATION ( \hat{Q} , \hat{K} , V , {\{ {l}_{i} \}}_{i = 1}^{k} ) \\ = ( 1 - β ) Roll ( V , 0 ) softmax ( \frac{1}{T} {Roll ( \hat{K} , 0 )}^{T} \hat{Q} ) ) \\ + β {\sum }_{i = 1}^{k} Roll ( V , {l}_{i} ) softmax ( \frac{1}{T} {Roll ( \hat{K} , {l}_{i} )}^{T} \hat{Q} ) )\end{matrix}$$

where T is a sequence length of multivariate time series (MTS) data, τ and β are learnable parameters, and k is a hyperparameter.

Given the teachings herein, the skilled artisan can implement suitable machine learning techniques and individual components thereof depicted herein in software on a general purpose computer 101 discussed below (optionally with a hardware accelerator); software on a special-purpose computer such as an array of graphics processing units (GPUs); non-Von Neumann machines; hardware; firmware; or a mixture of the forgoing. Indeed, a transformer is a type of neural network architecture that transforms an input sequence into an output sequence-given the teachings herein, the skilled artisan can implement suitable neural networks as just described, including inferencing. Although the overall architecture/techniques are entirely novel, certain individual elements/mechanisms/blocks required for implementation may adopt conventional elements/mechanisms/blocks, as would be apparent to one having ordinary skill in the relevant arts given the teachings herein.

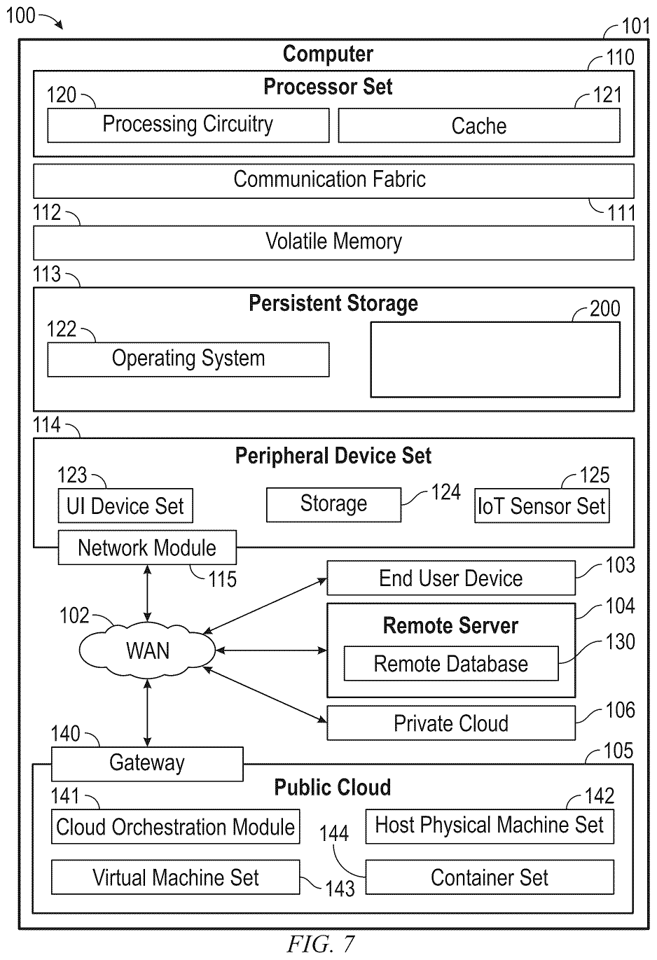

Refer now to FIG. 7.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as machine learning system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A machine learning system comprising:
input embedding layers;
a positional encoder configured to encode an embedding generated by the input embedding layers; and
N encoder blocks, each encoder block comprising:
a mixture-of-head-attention mechanism;
a first add and normalization mechanism configured to process an output of the mixture-of-head-attention mechanism;
a feed forward mechanism configured to process an output of the first add and normalization mechanism; and
a second add and normalization mechanism configured to process an output of the feed forward mechanism;
wherein the mixture-of-head-attention mechanism comprises:
a temporal-attention block configured to process an output of the positional encoder and comprising a temporal-attention head, a Q linear transformer configured to perform a linear transformation to generate a Q input for the temporal-attention head, a K linear transformer configured to perform a linear transformation to generate a K input for the temporal-attention head and a V linear transformer configured to perform a linear transformation to generate a V input for the temporal-attention head;
a correlated attention block configured to process the output of the positional encoder and comprising a score aggregator, a Q linear and normalization module configured to generate a correlated Q output, a K linear and normalization module configured to generate a correlated K output and a correlated V linear transformer configured to generate a correlated V output;
a lagged cross-correlation filtering mechanism configured to process outputs of the Q linear and normalization module and the K linear and normalization module, configured to carry out representation learning of correlation features comprising a top k highest correlation important scores to be filtered out, where k is a controlled parameter, and configured to produce an output for the score aggregator;
a concatenator configured to concatenate an output of the temporal-attention head and an output of the score aggregator; and
a combined linear transformer configured to process an output of the concatenator.

2. The machine learning system of claim 1, further comprising an inferencing engine configured to perform inferencing using the encoder blocks.

3. The machine learning system of claim 2, wherein the inferencing is for a task selected from the group consisting of gesture recognition, action recognition, audio recognition, and medical diagnosis by heartbeat monitoring.

4. The machine learning system of claim 1, wherein the lagged cross-correlation filtering mechanism is further configured to generate lagged key matrices and values of multivariate time series (MTS), to compute cross-correlation matrices between the lagged key matrices and query matrices and to compute sums of all entries of the cross-correlation matrices to filter out the top k highest correlation important scores, wherein, in the score aggregation, a top k of the cross-correlation matrices chosen in a cross-correlation filtering step are passed through a softmax operation, pre-multiplied by lagged values computed in a lag series generation step, and summed to generate a final score output.

5. The machine learning system of claim 1, wherein the first add and normalization mechanism is configured to perform a norm-2 normalization on an output of the combined linear block.

6. The machine learning system of claim 1, wherein the feed forward mechanism is configured to perform two feed forward linear transformations with a rectified linear unit (ReLU) activation function between the two feed forward linear transformations.

7. The machine learning system of claim 1, further comprising a decoder positional encoder and M decoder blocks, each decoder block comprising:
a mixture-of-head-attention mechanism configured to process outputs of the corresponding encoder block;
a masked mixture-of-head-attention mechanism configured to process an output of the decoder positional encoder;
a first decoder add and normalization mechanism configured to process an output of the masked mixture-of-head-attention mechanism and the output of the decoder positional encoder;
a second decoder add and normalization mechanism configured to process an output of the first decoder add and normalization mechanism and an output of the mixture-of-head-attention mechanism;
a decoder feed forward mechanism configured to process an output of the second decoder add and normalization mechanism; and
a third decoder add and normalization mechanism configured to process an output of the decoder feed forward mechanism and the output of the second decoder add and normalization mechanism.

8. The machine learning system of claim 7, wherein the masked mixture-of-head-attention mechanism comprises:
a decoder temporal-attention block configured to process the output of the decoder positional encoder and comprising a masked temporal-attention head, a decoder Q linear transformer configured to perform a linear transformation to generate a decoder Q input for the masked temporal-attention head, a decoder K linear transformer configured to perform a linear transformation to generate a decoder K input for the masked temporal-attention head and a decoder V linear transformer configured to perform a linear transformation to generate a decoder V input for the masked temporal-attention head;
a decoder correlated attention block configured to process the output of the decoder positional encoder and comprising a masked score aggregator, a decoder Q linear and normalization module configured to generate a decoder correlated Q output, a decoder K linear and normalization module configured to generate a decoder correlated K output and a decoder correlated V linear transformer configured to generate a decoder correlated V output;
a decoder lagged cross-correlation filtering mechanism for representation learning of most important decoder correlation features, the most important decoder correlation features comprising a top k highest decoder correlation important scores to be filtered out, where k is a decoder controlled parameter;
a decoder concatenator configured to concatenate an output of the masked temporal-attention head and an output of the masked score aggregator; and
a decoder combined linear transformer configured to process an output of the decoder concatenator.

9. The machine learning system of claim 7, wherein each decoder correlated attention block of each decoder block performs:
$$\begin{matrix}{l}_{1} , {l}_{2} , … , {l}_{k} = {argTopK}_{l ∈ [ 1 , T - 1 ]} {Roll ( K , l )}^{T} Q \\ MASKED - SCORE - AGGREGATION ( \hat{Q} , \hat{K} , V , {\{ {l}_{i} \}}_{i = 1}^{k} ) \\ = ( 1 - β ) Roll ( V , 0 ) softmax ( \frac{1}{T} mask ( {Roll ( \hat{K} , 0 )}^{T} \hat{Q} ) ) \\ + β {\sum }_{i = 1}^{k} Roll ( V , {l}_{i} ) softmax ( \frac{1}{T} mask ( {Roll ( \hat{K} , {l}_{i} )}^{T} \hat{Q} ) )\end{matrix}$$
where T is a sequence length of multivariate time series (MTS) data, τ and β are learnable parameters, and k is a hyperparameter.

10. The machine learning system of claim 1, wherein each correlated attention block of each encoder block performs:
$$\begin{matrix}{l}_{1} , {l}_{2} , … , {l}_{k} = {argTopK}_{l ∈ [ 1 , T - 1 ]} {Roll ( K , l )}^{T} Q \\ SCORE - AGGREGATION ( \hat{Q} , \hat{K} , V , {\{ {l}_{i} \}}_{i = 1}^{k} ) \\ = ( 1 - β ) Roll ( V , 0 ) softmax ( \frac{1}{T} {Roll ( \hat{K} , 0 )}^{T} \hat{Q} ) ) \\ + β {\sum }_{i = 1}^{k} Roll ( V , {l}_{i} ) softmax ( \frac{1}{T} {Roll ( \hat{K} , {l}_{i} )}^{T} \hat{Q} ) )\end{matrix}$$
where T is a sequence length of multivariate time series (MTS) data, τ and β are learnable parameters, and k is a hyperparameter.

11. A computer program product, comprising:
one or more tangible computer-readable storage media and program instructions stored on at least one of the one or more tangible computer-readable storage media, the program instructions executable by a processor to cause the processor to instantiate:
input embedding layers;
a positional encoder configured to encode an embedding generated by the input embedding layers; and
N encoder blocks, each encoder block comprising:
a mixture-of-head-attention mechanism;
a first add and normalization mechanism configured to process an output of the mixture-of-head-attention mechanism;
a feed forward mechanism configured to process an output of the first add and normalization mechanism; and
a second add and normalization mechanism configured to process an output of the feed forward mechanism;
wherein the mixture-of-head-attention mechanism comprises:
a temporal-attention block configured to process an output of the positional encoder and comprising a temporal-attention head, a Q linear transformer configured to perform a linear transformation to generate a Q input for the temporal-attention head, a K linear transformer configured to perform a linear transformation to generate a K input for the temporal-attention head and a V linear transformer configured to perform a linear transformation to generate a V input for the temporal-attention head;
a correlated attention block configured to process the output of the positional encoder and comprising a score aggregator, a Q linear and normalization module configured to generate a correlated Q output, a K linear and normalization module configured to generate a correlated K output and a correlated V linear transformer configured to generate a correlated V output;
a lagged cross-correlation filtering mechanism configured to process outputs of the Q linear and normalization module and the K linear and normalization module, configured to carry out representation learning of correlation features comprising a top k highest correlation important scores to be filtered out, where k is a controlled parameter, and configured to produce an output for the score aggregator;
a concatenator configured to concatenate an output of the temporal-attention head and an output of the score aggregator; and
a combined linear transformer configured to process an output of the concatenator.

12. The computer program product of claim 11, wherein the program instructions are further executable by the processor to cause the processor to instantiate an inferencing engine configured to perform inferencing using the encoder blocks.

13. The computer program product of claim 12, wherein the inferencing is for a task selected from the group consisting of gesture recognition, action recognition, audio recognition, and medical diagnosis by heartbeat monitoring.

14. The computer program product of claim 11, wherein the lagged cross-correlation filtering mechanism is further configured to generate lagged key matrices and values of multivariate time series (MTS), to compute cross-correlation matrices between the lagged key matrices and query matrices and to compute sums of all entries of the cross-correlation matrices to filter out the top k highest correlation important scores, wherein, in the score aggregation, a top k of the cross-correlation matrices chosen in a cross-correlation filtering step are passed through a softmax operation, pre-multiplied by lagged values computed in a lag series generation step, and summed to generate a final score output.

15. The computer program product of claim 11, wherein the first add and normalization mechanism is configured to perform a norm-2 normalization on an output of the combined linear block.

16. The computer program product of claim 11, wherein the feed forward mechanism is configured to perform two feed forward linear transformations with a rectified linear unit (ReLU) activation function between the two feed forward linear transformations.

17. The computer program product of claim 11, wherein the program instructions are further executable by the processor to cause the processor to instantiate a decoder positional encoder and M decoder blocks, each decoder block comprising:
a mixture-of-head-attention mechanism configured to process outputs of the corresponding encoder block;
a masked mixture-of-head-attention mechanism configured to process an output of the decoder positional encoder;
a first decoder add and normalization mechanism configured to process an output of the masked mixture-of-head-attention mechanism and the output of the decoder positional encoder;
a second decoder add and normalization mechanism configured to process an output of the first decoder add and normalization mechanism and an output of the mixture-of-head-attention mechanism;
a decoder feed forward mechanism configured to process an output of the second decoder add and normalization mechanism; and
a third decoder add and normalization mechanism configured to process an output of the decoder feed forward mechanism and the output of the second decoder add and normalization mechanism.

18. The computer program product of claim 17, wherein the masked mixture-of-head-attention mechanism comprises:
a decoder temporal-attention block configured to process the output of the decoder positional encoder and comprising a masked temporal-attention head, a decoder Q linear transformer configured to perform a linear transformation to generate a decoder Q input for the masked temporal-attention head, a decoder K linear transformer configured to perform a linear transformation to generate a decoder K input for the masked temporal-attention head and a decoder V linear transformer configured to perform a linear transformation to generate a decoder V input for the masked temporal-attention head;
a decoder correlated attention block configured to process the output of the decoder positional encoder and comprising a masked score aggregator, a decoder Q linear and normalization module configured to generate a decoder correlated Q output, a decoder K linear and normalization module configured to generate a decoder correlated K output and a decoder correlated V linear transformer configured to generate a decoder correlated V output;
a decoder lagged cross-correlation filtering mechanism for representation learning of most important decoder correlation features, the most important decoder correlation features comprising a top k highest decoder correlation important scores to be filtered out, where k is a decoder controlled parameter;
a decoder concatenator configured to concatenate an output of the masked temporal-attention head and an output of the masked score aggregator; and
a decoder combined linear transformer configured to process an output of the decoder concatenator.

19. The computer program product of claim 17, wherein each decoder correlated attention block of each decoder block performs:
$$\begin{matrix}{l}_{1} , {l}_{2} , … , {l}_{k} = {argTopK}_{l ∈ [ 1 , T - 1 ]} {Roll ( K , l )}^{T} Q \\ MASKED - SCORE - AGGREGATION ( \hat{Q} , \hat{K} , V , {\{ {l}_{i} \}}_{i = 1}^{k} ) \\ = ( 1 - β ) Roll ( V , 0 ) softmax ( \frac{1}{T} mask ( {Roll ( \hat{K} , 0 )}^{T} \hat{Q} ) ) \\ + β {\sum }_{i = 1}^{k} Roll ( V , {l}_{i} ) softmax ( \frac{1}{T} mask ( {Roll ( \hat{K} , {l}_{i} )}^{T} \hat{Q} ) )\end{matrix}$$
where T is a sequence length of multivariate time series (MTS) data, τ and β are learnable parameters, and k is a hyperparameter.

20. The computer program product of claim 11, wherein each correlated attention block of each encoder block performs:
$$\begin{matrix}{l}_{1} , {l}_{2} , … , {l}_{k} = {argTopK}_{l ∈ [ 1 , T - 1 ]} {Roll ( K , l )}^{T} Q \\ SCORE - AGGREGATION ( \hat{Q} , \hat{K} , V , {\{ {l}_{i} \}}_{i = 1}^{k} ) \\ = ( 1 - β ) Roll ( V , 0 ) softmax ( \frac{1}{T} {Roll ( \hat{K} , 0 )}^{T} \hat{Q} ) ) \\ + β {\sum }_{i = 1}^{k} Roll ( V , {l}_{i} ) softmax ( \frac{1}{T} {Roll ( \hat{K} , {l}_{i} )}^{T} \hat{Q} ) )\end{matrix}$$
where T is a sequence length of multivariate time series (MTS) data, τ and β are learnable parameters, and k is a hyperparameter.
